(19) United States
(12) Patent Application Publication
(10) Pub. No.: US 2012/0065934 A1
(43) Pub. Date: Mar. 15, 2012

(54) Member fatigue fracture probability estimating apparatus, member fatigue fracture probability estimating method, and computer readable medium

(76) Inventors: Hiroshi Shimanuki, Tokyo (JP); Tetsuro Nose, Tokyo (JP)

(21) Appl. No.: 13/373,219

(22) Filed: Nov. 7, 2011

(30) Foreign Application Priority Data
Apr. 1, 2009 (JP) 2009-089416
Mar. 31, 2010 (JP) 2010-082120

(51) Int. Cl. G06F 19/00

(52) U.S. Cl. 702/181

(57) ABSTRACT

An effective volume Vₑₚ of a member is calculated with a stress correction amount σ_{corr} added to an effective stress (stress amplitude) σᵢₚ at each position of the member so that a fatigue strength of the member varying corresponding to an average stress varying depending on the position of the member is apparently constant at a value when the average stress on the member is 0 (zero) irrespective of the position of the member, and a cumulative fracture probability P_{fp} due to fatigue of the member is derived using the effective volume Vₑₚ of the member.

### BACKGROUND OF THE INVENTION

1. Field of the Invention

The present invention relates to a member fatigue fracture probability estimating apparatus, a member fatigue fracture probability estimating method, and a computer program product and, particularly to, those which are preferably used to estimate the fracture probability due to fatigue of a machine part subjected to repeated loading.

2. Description of the Related Art

Conventionally, design of machine parts (metal parts and the like) subjected to repeated loading is often made to prevent fatigue fracture thereof. Specifically, a modified Goodman relationship is created from the fatigue strength and the fatigue limit obtained based on the result of a fatigue test of a material fatigue test piece and a tensile strength of the material. A fatigue limit diagram is created which is modified in consideration of the effects on fatigue characteristics such as the member dimension, the surface roughness, and the residual stress based on the modified Goodman relationship. Then, a required fatigue strength is found in consideration of the average stress on the part and the stress amplitude, and it is confirmed that the fatigue limit diagram is beyond the safety factor appropriate for the fatigue strength, whereby the fatigue strength design of the member is made (see, for example, Non-Patent Document 1 for a spring that is one of typical machine parts).

For handling variations in fatigue characteristics of material, a method of creating the P-S-N curve and a method of finding a cumulative probability distribution of the fatigue strength in a certain number of repeated loading times are disclosed in Japan Society of Mechanical Engineers Standard JSME S 002 (statistical fatigue test method).

Further, in the field of fatigue characteristic evaluation of a high-strength steel which possibly fractures starting from the inclusion such as a spring steel and the like, the volume of a region on which a stress of, for example, 90% of the maximum stress acts is referred to as a risk volume as an indicator of the size of a risk region that is the starting point of the fatigue fracture, and the size of the risk volume is evaluated (see Non-Patent Document 2).
[Non-Patent Document 1] Spring Technology Association, third edition, Maruzen, 1982, p 379-p 382
[Non-Patent Document 2] FURUYA Yoshiyuki, MATSUOKA Saburo, Inclusion Inspection Method in Ultra-sonic Fatigue Test, CAMP-ISIJ, Vol. 16, 2003, p 578

However, the above-described safety factor, the size of the risk volume, and the level of the stress as a reference are not based on any theoretical basis but experientially determined. Further, when a design is made in consideration of a very low fracture probability or a very long life, the variations caused by experiments cannot be sufficiently evaluated or many experiments are difficult to conduct in many cases. Accordingly, it is difficult to accurately estimate the fracture probability due to fatigue of the machine part.

### SUMMARY OF THE INVENTION

The present invention is made in consideration of the problem and its object is to make it possible to estimate more accurately than ever before the probability of fatigue fracture occurring with a low probability in a long life region of a machine part.

A member fatigue fracture probability estimating apparatus of the present invention includes: a processor executing at least: a first acquiring processing of acquiring, as first acquisition information, a Weibull coefficient m and a scale parameter σᵤ [N/mm²] when a cumulative fracture probability distribution with respect to a stress amplitude of a fatigue test in a certain number of repeated loading times of a material fatigue test piece made of a material constituting a member is expressed by a two-parameter Weibull distribution; a second acquiring processing of acquiring, as second acquisition information, an amplitude σᵢₚ [N/mm²] of a maximum principal stress or a corresponding stress at each position of the member and an average stress σₐᵥₑ [N/mm²] being an average of the maximum principal stress or the corresponding stress at each position of the member; a member effective volume deriving processing of deriving an effective volume Vₑₚ [mm³] of the member from following Equation (A) and Equation (B); and a member fracture probability deriving processing of deriving a cumulative fracture probability P_{fp} due to fatigue of the member from a following Equation (C); and a reporting unit reporting information relating to the cumulative fracture probability P_{fp} due to fatigue of the member.

Here, σₐₚ is a fatigue strength [N/mm²] of the member when the fatigue strength at each position is made uniform at a constant value using σᵢₚ+σ_{corr} as the amplitude of the stress at each position of the member, in a fatigue limit diagram representing a relation between the fatigue strength of the member and the average stress on the member, σᵣ is a fatigue strength [N/mm²] at a certain position when the average stress on the member is the average stress σₐᵥₑ at the position acquired in the second acquiring processing, in the fatigue limit diagram, max(x) represents a maximum value of x, and ∫dv represents volume integration of the whole member.

A member fatigue fracture probability estimating method of the present invention includes: a first acquiring step of acquiring, as first acquisition information, a Weibull coefficient m and a scale parameter σᵤ [N/mm²] when a cumulative fracture probability distribution with respect to a stress amplitude of a fatigue test in a certain number of repeated loading times of a material fatigue test piece made of a material constituting a member is expressed by a two-parameter Weibull distribution; a second acquiring step of acquiring, as second acquisition information, an amplitude σᵢₚ [N/mm²] of a maximum principal stress or a corresponding stress at each position of the member and an average stress σₐᵥₑ [N/mm²] being an average of the maximum principal stress or the corresponding stress at each position of the member; a member effective volume deriving step of deriving an effective volume Vₑₚ [mm³] of the member from following Equation (A) and Equation (B); and a member fracture probability deriving step of deriving a cumulative fracture probability P_{fp} due to fatigue of the member from a following Equation (C); and a reporting step of reporting information relating to the cumulative fracture probability P_{fp} due to fatigue of the member derived by the member fracture probability deriving step.

Here, σₐₚ is a fatigue strength [N/mm²] of the member when the fatigue strength at each position is made uniform at a constant value using σᵢₚ+σ_{corr} as the amplitude of the stress at each position of the member, in a fatigue limit diagram representing a relation between the fatigue strength of the member and the average stress on the member, σᵣ is a fatigue strength [N/mm²] at a certain position when the average stress at the position on the member is the average stress σₐᵥₑ acquired in the second acquiring step, in the fatigue limit diagram, max(x) represents a maximum value of x, and ∫dv represents volume integration of the whole member.

A computer program product of the present invention causes a computer to execute: a first acquiring step of acquiring a Weibull coefficient m and a scale parameter σᵤ [N/mm²] when a cumulative fracture probability distribution with respect to a stress amplitude of a fatigue test in a certain number of repeated loading times of a material fatigue test piece made of a material constituting a member is expressed by a two-parameter Weibull distribution; a second acquiring step of acquiring an amplitude σᵢₚ [N/mm²] of a maximum principal stress or a corresponding stress at each position of the member and an average stress σₐᵥₑ [N/mm²] being an average of the maximum principal stress or the corresponding stress at each position of the member; a member effective volume deriving step of deriving an effective volume Vₑₚ [mm³] of the member from following Equation (A) and Equation (B); and a member fracture probability deriving step of deriving a cumulative fracture probability P_{fp} due to fatigue of the member from a following Equation (C); and a reporting step of reporting information relating to the cumulative fracture probability P_{fp} due to fatigue of the member derived by the member fracture probability deriving step.

Here, σₐₚ is a fatigue strength [N/mm²] of the member when the fatigue strength at each position is made uniform at a constant value using σᵢₚ+σ_{corr} as the amplitude of the stress at each position of the member, in a fatigue limit diagram representing a relation between the fatigue strength of the member and the average stress on the member, σᵣ is a fatigue strength [N/mm²] at a certain position when the average stress at the position on the member is the average stress σₐᵥₑ acquired in the second acquiring step, in the fatigue limit diagram, max(x) represents a maximum value of x, and ∫dv represents volume integration of the whole member.

[Formula 1]

Vₑₚ=∫{(σᵢₚ+σ_{corr})/max(σᵢₚ+σ_{corr})}^{m}dV (A)

σ_{corr}=σₐₚ−σᵣ (B)

P_{fp}=1−exp[−Vₑₚ{max(σᵢₚ+σ_{corr})σᵤ}^{m}] (C)

### BRIEF DESCRIPTION OF THE DRAWINGS

FIG. 1 is a diagram illustrating an example of the hardware configuration of a member fatigue fracture probability estimating apparatus;

FIG. 2 is a diagram illustrating an example of the functional configuration of the member fatigue fracture probability estimating apparatus;

FIG. 3 is a diagram illustrating examples of the P-S-N curve;

FIG. 4 is a diagram illustrating an example of the Weibull plot;

FIG. 5 is a diagram illustrating examples of the relations between a position of a wire of a spring, and a fatigue strength of the spring and an acting stress;

FIG. 6 is a diagram representing an example of the modified Goodman relationship;

FIG. 7 is a flowchart explaining an example of the operation of the member fatigue fracture probability estimating apparatus;

FIG. 8 is a diagram illustrating the distribution of the residual stress of a coil spring in a first example; and

FIG. 9 is a diagram illustrating the distribution of the residual stress of a plate member in a second example.

### DETAILED DESCRIPTION OF THE PREFERRED EMBODIMENTS

Hereinafter, an embodiment of the present invention will be described with reference to the drawings.

<Hardware Configuration of a Member (Machine Part) Fatigue Fracture Probability Estimating Apparatus>

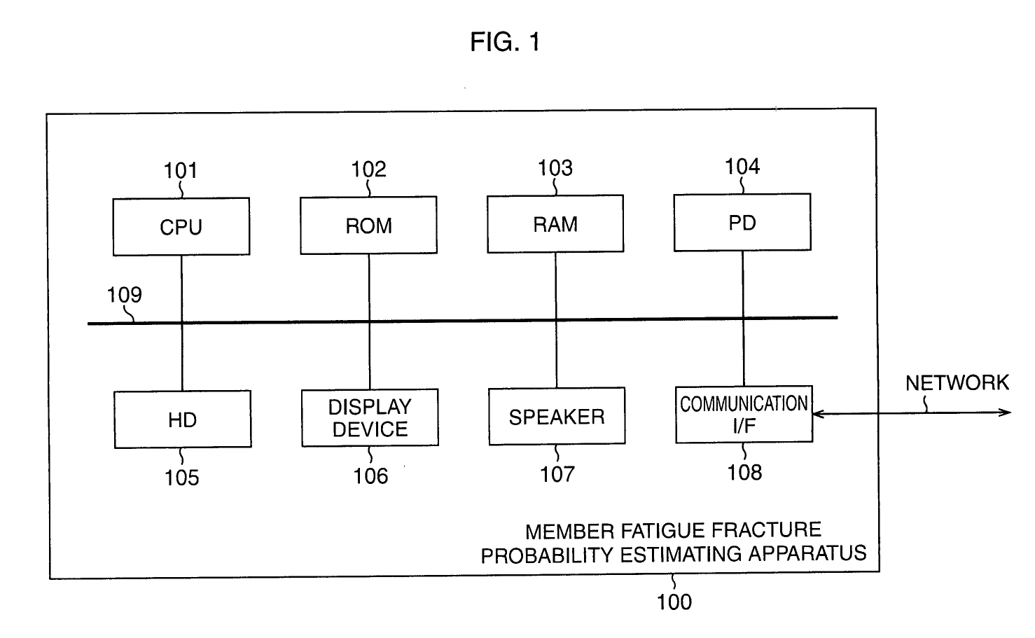

FIG. 1 is a diagram illustrating an example of the hardware configuration of a member fatigue fracture probability estimating apparatus 100.

As illustrated in FIG. 1, the member fatigue fracture probability estimating apparatus 100 has a CPU (Central Processing Unit) 101, a ROM (Read Only Memory) 102, a RAM (Random Access Memory) 103, a PD (Pointing Device) 104, an HD (Hard Disk) 105, a display device 106, a speaker 107, a communication I/F (Interface) 108, and a system bus 109.

The CPU 101 is a processor collectively controlling the operation in the member fatigue fracture probability estimating apparatus 100. The CPU 101 controls components (102 to 108) of the member fatigue fracture probability estimating apparatus 100 via the system bus 109.

The ROM 102 stores a BIOS (Basic Input/Output System) that is a control program of the CPU 101, an operating system program (OS), and a program necessary for the CPU 101 to execute processing according to a later-descried flowchart and so on.

The RAM 103 functions as a main memory, a work area and the like of the CPU 101. When executing processing, the CPU 101 loads necessary computer programs and the like from the ROM 102 and necessary information and the like from the HD 105 into the RAM 103. The CPU 101 then executes the computer programs and the like and the information and the like loaded into the RAM 103 to thereby implement various operations.

The PD 104 is composed of, for example, a mouse, a keyboard and the like. The PD 104 constitutes an operation input unit for the operator to perform, when necessary, an operation input to the member fatigue fracture probability estimating apparatus 100.

The HD 105 constitutes a memory storing various kinds of information, data, and files and the like.

The display device 106 constitutes a display unit displaying various kinds of information and images based on the control of the CPU 101.

The speaker 107 constitutes a voice output unit outputting voice relating to various kinds of information based on the control of the CPU 101.

The communication I/F 108 performs communication of various kinds of information and the like with an external device over a network based on the control of the CPU 101.

The system bus 109 is a bus for connecting the CPU 101, the ROM 102, the RAM 103, the PD 104, the HD 105, the display device 106, the speaker 107 and the communication I/F 108 such that they can communicate with each other.

<Member Fatigue Fracture Probability Estimating Apparatus>

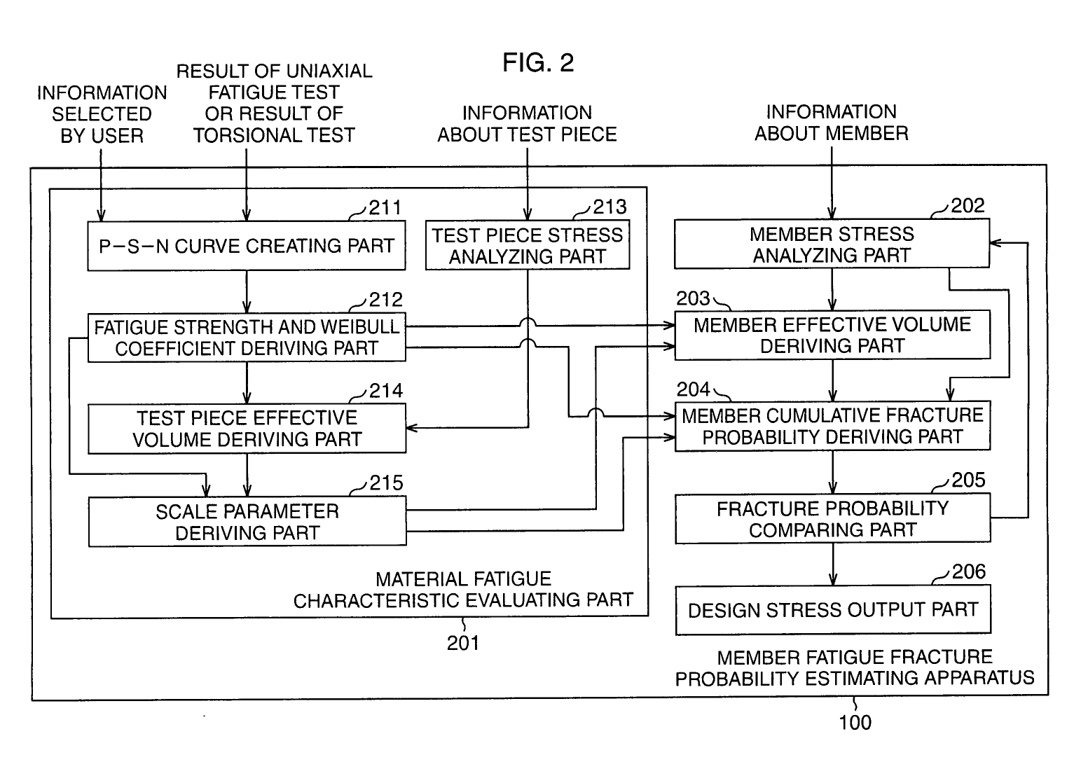

FIG. 2 is a diagram illustrating an example of the functional configuration of the member fatigue fracture probability estimating apparatus 100.

In FIG. 2, the member fatigue fracture probability estimating apparatus 100 has a material fatigue characteristic evaluating part 201, a member stress analyzing part 202, a member effective volume deriving part 203, a member cumulative fracture probability deriving part 204, a fracture probability comparing part 205, and a design stress output part 206.

The material fatigue characteristic evaluating part 201 has a function of evaluating the fatigue characteristic of a material (metal (for example, steel material) or the like) or the like constituting the member that is the object of deriving the cumulative fracture probability. Specifically, the material fatigue characteristic evaluating part 201 has a P-S-N curve creating part 211, a fatigue strength and Weibull coefficient deriving part 212, a test piece stress analyzing part 213, a test piece effective volume deriving part 214, and a scale parameter deriving part 215.

The P-S-N curve creating part 211 receives input of the result of a uniaxial fatigue test conducted in a state that the average stress σₐᵥₑ at each position of the material fatigue test piece is 0 [N/mm²] (the result of a uniaxial fatigue test). In this embodiment, the uniaxial fatigue test is conducted on a plurality of material fatigue test pieces under a test stress σₜ with a constant stress amplitude, and then the uniaxial fatigue test is similarly conducted on the plurality of material fatigue test pieces with the stress amplitude changed. The uniaxial fatigue test here means a test of repeatedly loading the test stress σₜ (compression and tensile stress) regularly changed in one direction on the material fatigue test piece to investigate the number of times of repeatedly loading the test stress σₜ until the material fatigue test piece breaks. The average stress σₐᵥₑ at each position of the material fatigue test piece is, for example, the arithmetic average of the maximum value and the minimum value of the maximum principal stress or the corresponding stress which is found at each position of the material fatigue test piece. The material fatigue test piece is a test piece of the material constituting the member. A test piece having the same shape and size as those of the test piece which is generally used in the uniaxial fatigue test can be employed as the material fatigue test piece.

Further, the P-S-N curve creating part 211 receives input of the result of a torsional fatigue test conducted in a state that the average stress τₐᵥₑ at each position of the material fatigue test piece is 0 [N/mm²]. In this embodiment, the torsional fatigue test is conducted on a plurality of material fatigue test pieces under a test stress τₜ with a constant stress amplitude, and then the torsional fatigue test is similarly conducted on the plurality of material fatigue test pieces with the stress amplitude changed. The torsional fatigue test here means a test of repeatedly loading the test stress τₜ (shear stress) regularly changed in a shear direction on the material fatigue test piece to investigate the number of times of repeatedly loading the test stress τₜ until the material fatigue test piece breaks. The average stress τₐᵥₑ at each position of the material fatigue test piece is, for example, the arithmetic average of the maximum value and the minimum value of the maximum principal stress or the corresponding stress which is found at each position of the material fatigue test piece. The material fatigue test piece is a test piece of the material constituting the member. A test piece having the same shape and size as those of the test piece which is generally used in the torsional fatigue test can be employed as the material fatigue test piece.

The P-S-N curve creating part 211 can receive input of the results of the uniaxial fatigue test and the torsional fatigue test, for example, in the following manner. The P-S-N curve creating part 211 can acquire information about the results of the uniaxial fatigue test and the torsional fatigue test based on the operation contents of the user interface. The P-S-N curve creating part 211 can read the information about the results of the uniaxial fatigue test and the torsional fatigue test stored in the hard disk of a personal computer and a transportable memory. The P-S-N curve creating part 211 can acquire the information about the results of the uniaxial fatigue test and the torsional fatigue test received from the external part over the network. Note that expression of the unit relating to the stress will be omitted as necessary in the following description.

As described above, both of the result of the uniaxial fatigue test and the result of the torsional fatigue test can be acquired as the fatigue characteristics of the material in this embodiment. Further, the user can select whether to use the result of the uniaxial fatigue test or the result of the torsional fatigue test as the fatigue characteristics of the material, for example, based on the operation contents of the user interface.

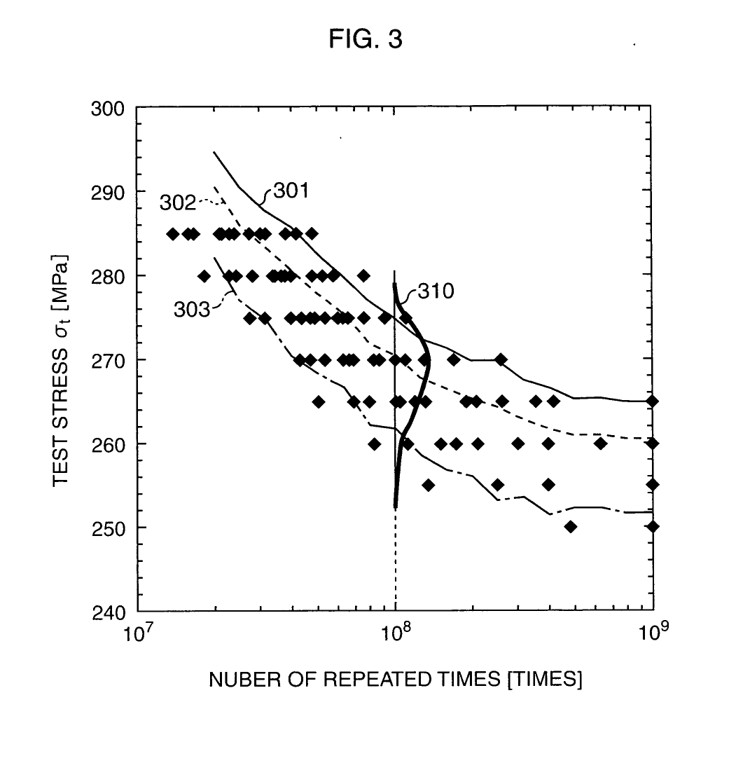

The P-S-N curve creating part 211 creates a P-S-N curve using the result of the test according to the result selected by the user (the result of the uniaxial fatigue test or the torsional fatigue test). The P-S-N curve is a curve indicating the relation between the number of repeated loading times in the test and the test stress σₜ (stress amplitude of compression and tensile stress) or τₜ (stress amplitude of shear stress) loaded on the material fatigue test piece which has broken in the number of repeated loading times. FIG. 3 is a diagram illustrating examples of the P-S-N curve. Note that FIG. 3 illustrates examples of the P-S-N curve when the test stress (stress amplitude) is the compression and tensile stress (stress amplitude) σₜ. The P-S-N curve when the test stress (stress amplitude) is the shear stress (stress amplitude) τₜ is different only in shape and value of the curve from those illustrated in FIG. 3, and therefore the illustration thereof will be omitted here.

The fatigue strength and Weibull coefficient deriving part 212 finds a fatigue strength distribution function 310 from values of P-S-N curves 301 to 303 in a target number of repeated loading times (the target number of repeated loading times is 10⁸ times in this embodiment). In this embodiment, the fatigue strength and Weibull coefficient deriving part 212 finds the fatigue strength distribution function 310 by the method of Japan Society of Mechanical Engineers Standard JSME S 002 (statistical fatigue test method) whose distribution function used therein is replaced with the Weibull distribution function. Specifically, in this embodiment, the fatigue strength and Weibull coefficient deriving part 212 creates the Weibull plot indicating the relation between the values of the P-S-N curves 301 to 303 in the target number of repeated loading times (10⁸ times) (the value found by taking the natural logarithm of the test stress (stress amplitude) σₜ or τₜ loaded on the material fatigue test piece (=1nσₜ or 1nτₜ)) and the value found by taking twice the natural logarithm of (1/(1−F)) where the cumulative fracture probability of the material fatigue test piece is F (=1n1n(1/(1−F)).

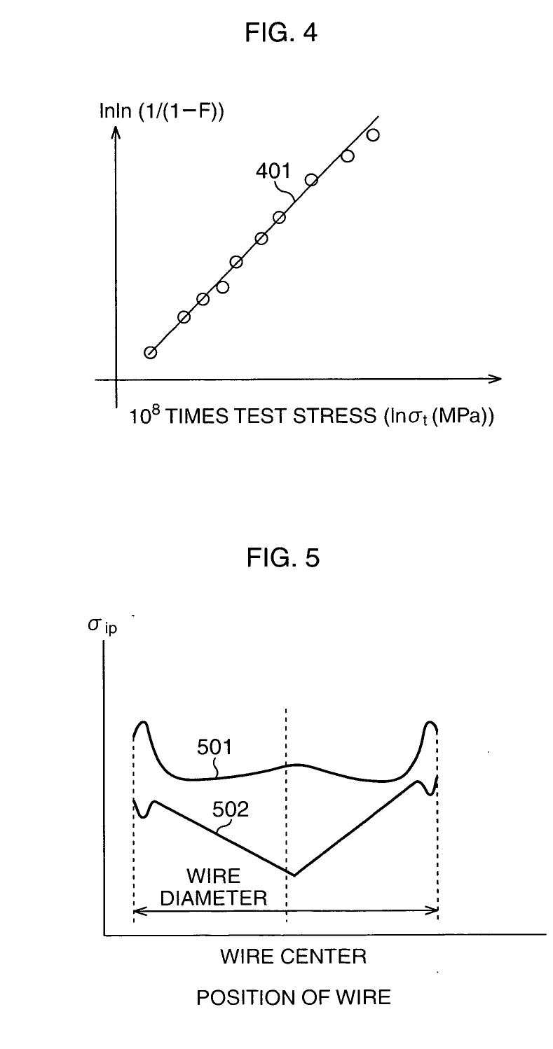

FIG. 4 is a diagram illustrating an example of the Weibull plot. Note that FIG. 4 illustrates the example of the Weibull plot when the test stress (stress amplitude) is the compression and tensile stress (stress amplitude) σₜ. The Weibull plot when the test stress (stress amplitude) is the shear stress (stress amplitude) τₜ is different only in shape and value of the curve from those illustrated in FIG. 4, and therefore the illustration thereof will be omitted here. As described above, it is assumed that the cumulative fracture probability F with respect to the stress amplitude of the fatigue test in a certain number of repeated loading times with the average stress on the material fatigue test piece being 0 [N/mm²] is expressed by the two-parameter Weibull distribution in this embodiment. This cumulative fracture probability (two-parameter Weibull distribution) F is expressed by the following Equation (1).

[Formula 2]

F=1−exp{−(σᵢ/σᵤ)^{m}}=1−exp{−Vₑₛ−(max(σᵢ)/σᵤ)^{m}} (1)

In Equation (1), σᵢ is the maximum principal stress or corresponding stress (stress amplitude) [N/mm²] at each position of the material fatigue test piece. Further, σᵤ is the scale parameter [N/mm²] when the cumulative fracture probability with respect to the stress amplitude in a certain number of repeated loading times on the assumption that the fatigue test (for example, the uniaxial fatigue test or the torsional fatigue test) by repeated loading with the average stress on the material being 0 [N/mm²] has been conducted, which is expressed by the two-parameter Weibull distribution. Here, the certain number of repeated loading times is preferably but not necessarily the above-described target number of repeated loading times. Note that the scale parameter σᵤ of the fracture strength on the assumption that the fatigue test is conducted on the material in the certain number of repeated loading times is referred to as a scale parameter σᵤ of the material or a scale parameter σᵤ as necessary in the following description. Further, Vₑₛ is the effective volume [mm³] of the material fatigue test piece. Here, the effective volume represents the indicator of the size of a region where the fatigue fracture occurs.

Further, m is the Weibull coefficient when the cumulative fracture probability with respect to the stress amplitude in a certain number of repeated loading times, on the assumption that the fatigue test (for example, the uniaxial fatigue test or the torsional fatigue test) by repeated loading with the average stress on the material fatigue test piece being 0 [N/mm²] is conducted, which is expressed by the two-parameter Weibull distribution. Here, the Weibull coefficient m represents the variations in the fatigue strength in the certain number of repeated loading times. Further, the certain number of repeated loading times may be the above-described target number of repeated loading times or another number of times. Note that though the Weibull coefficient when the cumulative fracture probability in the state that the average stress on the material fatigue test piece is 0 [N/mm²] is expressed by the two-parameter Weibull distribution is employed here, the average stress is not limited to 0 [N/mm²]. Further, the cumulative fracture probability with respect to the stress amplitude of the fatigue test in the certain number of repeated loading times on the assumption that the fatigue test by repeated loading with the average stress on the material fatigue test piece being 0 [N/mm²] is referred to as a Weibull coefficient m of the material fatigue test piece or a Weibull coefficient m as necessary in the following description.

Further, max(x) represents the maximum value of x (this also applies to max(x) in the following equation). Note that expression of the unit relating to the effective volume will be omitted as necessary in the following description. Further, the maximum principal stress or the corresponding stress (stress amplitude) σᵢ at each position of the material fatigue test piece is referred to as an effective stress (stress amplitude) σᵢ at each position of the material fatigue test piece as necessary.

The fatigue strength and Weibull coefficient deriving part 212 derives the P-S-N curves 301, 302, 303 indicating the S-N curve at a certain cumulative fracture probability from the plot of the fatigue test result. The fatigue strength and Weibull coefficient deriving part 212 then derives, as the Weibull coefficient, the inclination of a straight line 401 obtained by applying the distribution characteristic of the fatigue strength in the certain number of repeated loading times from the result to the Weibull distribution 310.

When use of the result of the uniaxial fatigue test as the fatigue characteristic of the material is selected by the user, the fatigue strength and Weibull coefficient deriving part 212 derives an average fatigue strength σₐₛ of the material fatigue test piece from the results of a plurality of uniaxial fatigue tests. The average fatigue strength Gas of the material fatigue test piece is the expected value (average value) of the fatigue strength of the material fatigue test piece obtained from the results of the uniaxial fatigue tests conducted with the average stress on the plurality of material fatigue test pieces being 0 [N/mm²].

On the other hand, when use of the result of the torsional fatigue test as the fatigue characteristic of the material is selected by the user, the fatigue strength and Weibull coefficient deriving part 212 finds an average shear stress (stress amplitude) τₐₛ on the surface of the material fatigue test piece from the results of a plurality of torsional fatigue tests. When the principal stress (stress amplitude) is used as σᵢ in Equation (1), the fatigue strength and Weibull coefficient deriving part 212 uses the average shear stress (stress amplitude) τₐₛ as the average fatigue strength σₐₛ of the material fatigue test piece. On the other hand, when the corresponding stress (stress amplitude) is used as σᵢ in Equation (1), the fatigue strength and Weibull coefficient deriving part 212 uses the value obtained by multiplying the average shear stress (stress amplitude) τₐₛ by a coefficient f (1≦f≦√3) as the average fatigue strength σₐₛ of the material fatigue test piece. The average fatigue strength σₐₛ of the material fatigue test piece is the expected value (average value) of the fatigue strength of the material fatigue test piece obtained from the results of the torsional fatigue tests conducted with the average stress on the plurality of material fatigue test pieces being 0 [N/mm²]. Here, the coefficient f is a coefficient based on the difference between the shear stress and the axial force and shall be set in advance in the member fatigue fracture probability estimating apparatus 100 based on the operation of the user interface by the user. The user can appropriately decide an arbitrary value not less than 1 and not greater than √3 as the coefficient f according to the experimental result or the like. When a value out of this range is selected (inputted) as the coefficient f, the member fatigue fracture probability estimating apparatus 100 does not employ the selected coefficient f but reports selection of a value within this range to the user.

The test piece stress analyzing part 213 receives input of information about the material fatigue test piece such as the shape of the material fatigue test piece, the conditions of the load applied on the material fatigue test piece, and the material strength (for example, the tensile strength, the yield stress, and the work-hardening characteristic). The test piece stress analyzing part 213 can receive input of the information about the material fatigue test piece as follows for instance. The test piece stress analyzing part 213 can acquire the information about the material fatigue test piece based on the operation contents of the user interface. The test piece stress analyzing part 213 can read the information about the material fatigue test piece stored in the hard disk of a personal computer and a transportable memory. The test piece stress analyzing part 213 can acquire the information about the material fatigue test piece received from the external part over the network.

The test piece stress analyzing part 213 then derives the effective stress (stress amplitude) σᵢ at each position of the material fatigue test piece using the inputted information about the material fatigue test piece. The effective stress (stress amplitude) σᵢ at each position of the material fatigue test piece can be derived by performing analysis using FEM (Finite Element Method) or BEM (Boundary element method) or by performing calculation using the method by the strength of materials. The derivation of the effective stress (stress amplitude) σᵢ at each position of the material fatigue test piece can be implemented by a publicly known method, and therefore the detailed description thereof will be omitted here.

The test piece effective volume deriving part 214 derives the effective volume Vₑₛ of the material fatigue test piece from the following Equation (2) using “the Weibull coefficient m of the material fatigue test piece” derived by the fatigue strength and Weibull coefficient deriving part 212 and “the effective stress (stress amplitude) σᵢ at each position of the material fatigue test piece” derived by the test piece stress analyzing part 213. Note that ∫ in Equation (2) represents volume integration of the whole material fatigue test piece.

[Formula 3]

Vₑₛ=∫{σᵢ/max(σᵢ)}^{m}dv (2)

The scale parameter deriving part 215 derives the scale parameter σᵤ of the material from the following Equation (3) using “the Weibull coefficient m of the material fatigue test piece and the average fatigue strength σₐₛ of the material fatigue test piece” derived by the fatigue strength and Weibull coefficient deriving part 212 and “the effective volume Vₑₛ of the material fatigue test piece” derived by the test piece effective volume deriving part 214. Note that Γ( ) in Equation (3) represents the gamma function (this also applies to the expression in the following equations).

[Formula 4]

σᵤ=σₐₛVₑₛ^{1/m}/Γ(1+1/m) (3)

The member stress analyzing part 202 receives input of information about member and external force such as the shape of a member, the acting external force acting on the member (the load applied on the member), the residual stress of the member, the material strength of the member (for example, the tensile strength, the yield stress, and the work-hardening characteristic), and the tensile strength σ_{b} of the material. The member stress analyzing part 202 can receive input of the information about the member and external force as follows for instance. The member stress analyzing part 202 can acquire the information about the member and external force based on the operation contents of the user interface. The member stress analyzing part 202 can read the information about the member and external force stored in the hard disk of a personal computer and a transportable memory. The member stress analyzing part 202 can acquire the information about the member and external force received from the external part over the network.

The member stress analyzing part 202 then derives the maximum stress or corresponding stress (stress amplitude) σᵢₚ at each position of the member and the average stress σₐᵥₑ at each position of the member (for example, the arithmetic average of the maximum value and the minimum value of the maximum principal stress or the corresponding stress) using the inputted information about the member and external force. They can be derived as follows for instance. The member stress analyzing part 202 first estimates the residual stress of the member based on the thermal stress analysis and the measurement result of the residual stress. The member stress analyzing part 202 further estimates the stress occurring inside the member with respect to the acting external force by performing analysis using FEM or BEM or by performing calculation using the method by the strength of materials. The member stress analyzing part 202 then superposes the residual stress of the member on the stress occurring inside the member to estimate the stress state inside the member. From the stress state inside the member, the maximum stress or corresponding stress (stress amplitude) σᵢₚ at each position of the member and the average stress σₐᵥₑ at each position of the member are derived. The derivation of them can be implemented by a publicly known method, and therefore the detailed description thereof will be omitted here. Note that the maximum stress or corresponding stress (stress amplitude) σᵢₚ at each position of the member is referred to as an effective stress (stress amplitude) σᵢₚ at each position of the member as necessary in the following description.

The member effective volume deriving part 203 derives the effective volume Vₑₚ of the member based on the following Equation (4). Note that ∫ in Equation (4) represents volume integration of the whole member. As described above, σᵢₚ is the effective stress (stress amplitude) at each position of the member. Further, σ_{corr} is a stress correction amount for correcting the effect of the average stress σₐᵥₑ at each position of the member on the fatigue strength of the member and is expressed by the following Equation (5). In Equation (5), σₐₚ represents a fatigue strength of the member when the average stress on the member is 0 (zero), in a fatigue limit diagram representing the relation between the fatigue strength of the member and the average stress on the member. Further, σᵣ represents a fatigue strength at a certain position when the average stress on the member is “the average stress σₐᵥₑ” at the position derived by the member stress analyzing part 202, in the fatigue limit diagram. Note that the fatigue strength σₐₚ of the member when the average stress on the member is 0 (zero) in the fatigue limit diagram is referred to as a fatigue strength σₐₚ of the member at a position with the average stress of 0 as necessary in the following description. Further, the fatigue strength σᵣ at a certain position when the average stress on the member is “the average stress σₐᵥₑ” at the position derived by the member stress analyzing part 202 in the fatigue limit diagram is referred to as a fatigue strength σᵣ of the member at each position as necessary.

[Formula 5]

Vₑₚ=∫{(σᵢₚ+σ_{corr})/max(σᵢₚ+σ_{corr})}^{m}dv (4)

σ_{corr}=σₐₚ−σᵣ (5)

FIG. 5 is a diagram illustrating examples of the relations between a position of a wire of a spring, and local fatigue strength 501 and acting stress 502 at the position. The fatigue strength 501 of the spring and the acting stress 502 are not constant at positions in the cross-section of the wire as illustrated in FIG. 5 because deformation mainly caused by torsion occurs in the spring and compressive residual stress caused by working or shot peening or the like of the spring exists on the surface of the spring. Generally, the fatigue strength of the member differs in value depending on the position within the member because of the effect of the average stress σₐᵥₑ at each position of the member. Hence, the stress correction amount σ_{corr} is added to the effective stress (stress amplitude) σᵢₚ at each position of the member so that the fatigue strength of the member is apparently constant at the value when the average stress on the member is 0 (zero) irrespective of the position of the member as expressed in Equation (4) in this embodiment. This makes it possible to appropriately evaluate the effective volume Vₑₚ of the member even using the result of the uniaxial fatigue test at the same average stress (here, the average stress 0) (the Weibull coefficient m of the material fatigue test piece, the scale distribution σᵤ of the material).

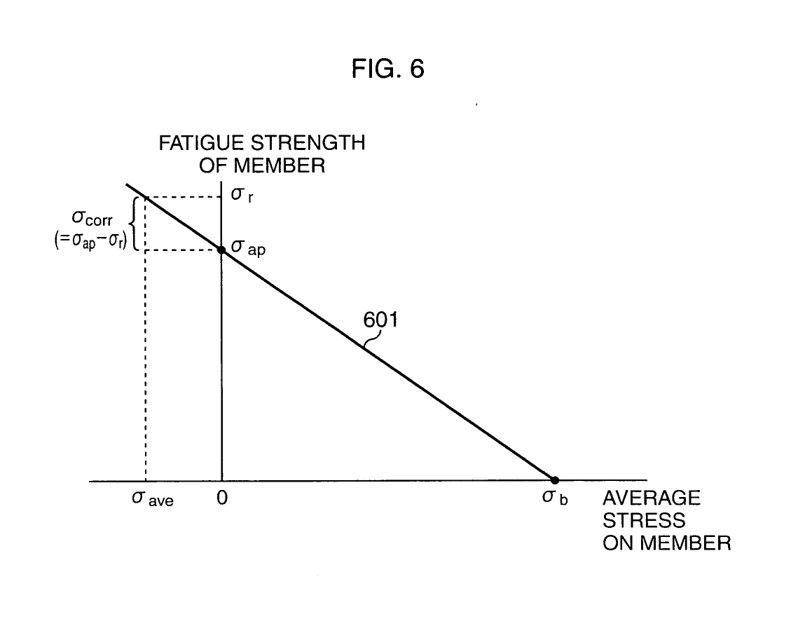

Further, in this embodiment, the effective volume Vₑₚ of the member is derived using a modified Goodman relationship as the fatigue limit diagram. FIG. 6 is a diagram representing an example of the modified Goodman relationship. As illustrated in FIG. 6, a modified Goodman relationship 601 is expressed by a straight line linking “the tensile strength σ_{b} of the material” inputted by the member stress analyzing part 202 and “the fatigue strength σₐₚ of the member at the position with the average stress of 0” described above. When the modified Goodman relationship is used as the fatigue limit diagram, the fatigue strength σₐₚ of the member at the position with the average stress of 0 and the stress correction amount σ_{corr} are expressed by the following Equation (6) and Equation (7) respectively. Thus, when the effective volume Vₑₚ of the member is derived using the modified Goodman relationship as the fatigue limit diagram, the above-described Equation (4) can be rewritten as the following Equation (8).

Note that the description in this embodiment is made on the basis of the case that the average stress in the fatigue test is 0. This is because the fatigue test method with the average stress of 0 such as an ultrasonic fatigue test is considered to be a general method in collection of data of many long life regions. However, use of the modified Goodman relationship makes it possible to perform the similar fatigue fracture probability estimation even on the basis of another average stress. Therefore, in this method, evaluation as in the case that the average stress is 0 is possible even if the average stress on the material fatigue test piece or the member to which the fatigue strength used as the basis for evaluation is imparted is changed to another value. In other words, FIG. 6 illustrates the case that the average stress on the member which is the basis for evaluation is 0 as an example. However, for example, σₐₚ can be the fatigue strength of the member when the fatigue strength at each position is made uniform at a constant value using σᵢₚ+σ_{corr} as the stress at each position of the member in the fatigue limit diagram.

[Formula 6]

σₐₚ=σᵤVₑₚ^{-1/m}Γ(1+1/m) (6)

σ_{corr}=σₐₚσₐᵥₑ/σ_{b} (7)

Vₑₚ=∫{(σᵢₚ+Vₑₚ^{-1/m}σᵤΓ(1+1/m)σₐᵥₑ/σ_{b})/max(σᵢₚ+Vₑₚ^{-1/m}σᵤΓ(1+1/m)σₐᵥₑ/σ_{b})}^{m}dV (8)

Accordingly, the member effective volume deriving part 203 derives the effective volume Vₑₚ of the member from Equation (8) using “the effective stress (stress amplitude) σᵢₚ at each position of the member, the average stress σₐᵥₑ at each position of the member, and the tensile strength σ_{b} of the material” derived by the member stress analyzing part 202, “the Weibull coefficient m of the material fatigue test piece” derived by the fatigue strength and Weibull coefficient deriving part 212, and “the scale parameter σᵤ of the material” derived by the scale parameter deriving part 215 in this embodiment. Note that since the effective volume Vₑₚ of the material is described on both of the right side and the left side in Equation (8), the member effective volume deriving part 203 performs convergence calculation to derive the effective volume Vₑₚ of the member. Note that the convergence calculation can be implemented by a publicly known method, and therefore the detailed description thereof will be omitted here. The member effective volume deriving part 203 further derives the stress correction amount σ_{corr} a from the above-described Equation (6) and Equation (7).

The member cumulative fracture probability deriving part 204 derives a fracture probability P_{fp} due to fatigue of the member from Equation (9) using “the effective stress (stress amplitude) σᵢₚ at each position of the member” derived by the member stress analyzing part 202, “the effective volume Vₑₚ of the member, the stress correction amount σ_{corr}” derived by the member effective volume deriving part 203, and “the Weibull coefficient m of the material fatigue test piece” derived by the fatigue strength and Weibull coefficient deriving part 212, and “the scale parameter σᵤ of the material” derived by the scale parameter deriving part 215.

[Formula 7]

P_{fp}=1−exp[−Vₑₚ{max(σᵢₚ−σ_{corr})/σᵤ}^{m}] (9)

The fracture probability comparing part 205 determines whether or not the cumulative fracture probability P_{fp} due to fatigue of the member derived by the member cumulative fracture probability deriving part 204 is equal to or less than a target cumulative fracture probability set in advance by the user. When the cumulative fracture probability P_{fp} due to fatigue of the member is not equal to or less than the target cumulative fracture probability as a result of the determination, the member stress analyzing part 202 requests the user to change the information about the member by displaying a screen (GUI) requesting change of the information about the member. The member stress analyzing part 202 derives again the effective stress (stress amplitude) σᵢₚ at each position of the member and the average stress σₐᵥₑ at each position of the member using the information about the member inputted in response to this request. With the change of the information, the member effective volume deriving part 203 derives again the effective volume Vₑₚ of the member, and the member cumulative fracture probability deriving part 204 derives again the cumulative fracture probability P_{fp} due to fatigue of the member. Such processing is repeatedly performed until the cumulative fracture probability P_{fp} due to fatigue of the member reaches the target cumulative fracture probability or less.

When the cumulative fracture probability P_{fp} reaches the target cumulative fracture probability or less in this manner, the design stress output part 206 derives a design stress on the member based on the information derived by the member stress analyzing part 202 at the time when the cumulative fracture probability P_{fp} reaches the target cumulative fracture probability or less. The design stress output part 206 then displays the screen (GUI) indicating the design stress on the member to report the design stress on the member to the user.

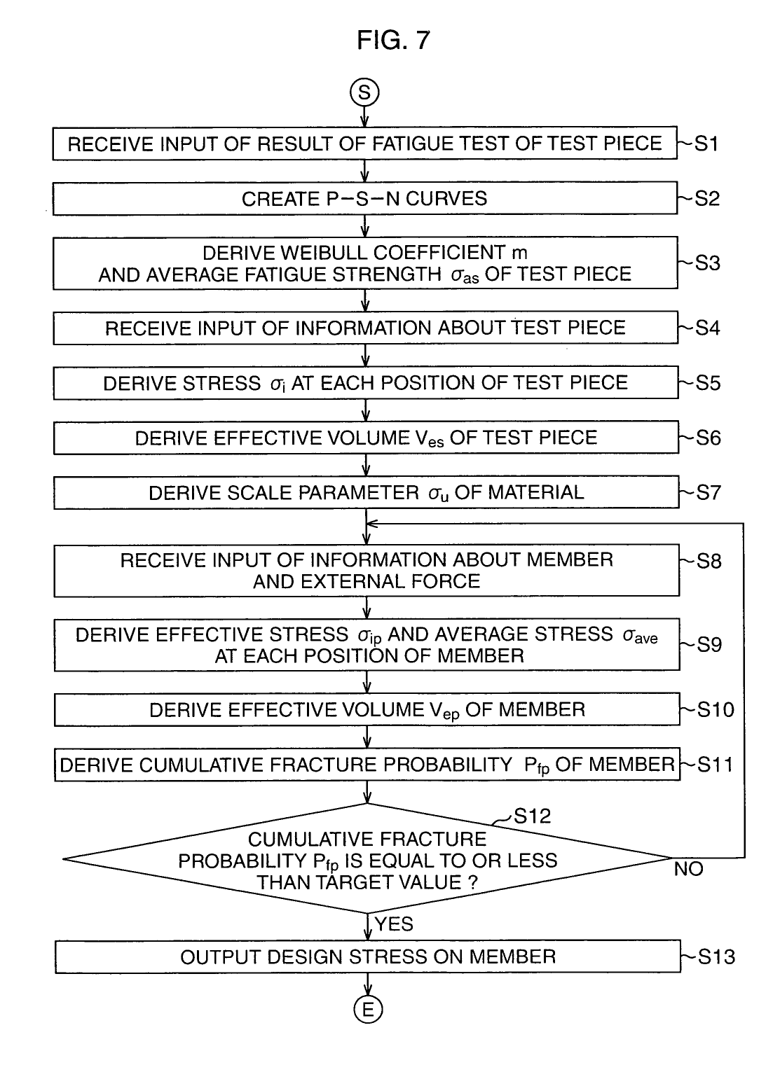

An example of the operation of the member fatigue fracture probability estimating apparatus 100 will be described next with reference to the flowchart in FIG. 7.

First, at step S1, the P-S-N curve creating part 211 receives input of the result of the uniaxial fatigue test and the result of the torsional fatigue test about the material fatigue test piece.

Then, at step S2, the P-S-N curve creating part 211 creates the P-S-N curves (see the P-S-N curves 301 to 303 in FIG. 3) using the result of the test selected by the user among the result of the uniaxial fatigue test and the result of the torsional fatigue test inputted at step S1.

Subsequently, at step S3, the fatigue strength and Weibull coefficient deriving part 212 creates the Weibull plot (see each plot (◯) illustrated in FIG. 4) using the P-S-N curves created at step S2 and derives the Weibull coefficient m of the material fatigue test piece from the created Weibull plot. The fatigue strength and Weibull coefficient deriving part 212 further derives the average fatigue strength σₐₛ of the material fatigue test piece from the result of the uniaxial fatigue test.

Then, at step S4, the test piece stress analyzing part 213 receives input of information about the material fatigue test piece.

Then, at step S5, the test piece stress analyzing part 213 derives the effective stress (stress amplitude) σᵢ at each position of the material fatigue test piece using the inputted information about the material fatigue test piece.

Note that the processing at steps S4 and S5 may be performed before step S1.

Then, at step S6, the test piece effective volume deriving part 214 derives the effective volume Vₑₛ of the material fatigue test piece from Equation (2) using “the Weibull coefficient m of the material fatigue test piece” derived at step S3 and “the effective stress (stress amplitude) σᵢ at each position of the material fatigue test piece” derived at step S5.

Then, at step S7, the scale parameter deriving part 215 derives the scale parameter σᵤ of the material from Equation (3) using “the Weibull coefficient m of the material fatigue test piece, the average fatigue strength σₐₛ of the material fatigue test piece” derived at step S3 and “the effective volume Vₑₛ of the material fatigue test piece” derived at step S6.

Then, at step S8, the member stress analyzing part 202 receives input of information about the member and external force.

Then, at step S9, the member stress analyzing part 202 derives the effective stress (stress amplitude) σᵢₚ at each position of the member and the average stress σₐᵥₑ at each position of the member using the inputted information about the member and external force.

Note that steps S8 and S9 may be performed before step S7.

Then, at step S10, the member effective volume deriving part 203 derives the effective volume Vₑₚ of the member from Equation (8) using “the tensile strength σ_{b} of the material” inputted at step S8, “the effective stress (stress amplitude) σᵢₚ at each position of the member and the average stress σₐᵥₑ at each position of the member” derived at step S9, “the Weibull coefficient m of the material fatigue test piece” derived at step S3, and “the scale parameter σᵤ of the material” derived at step S7. The member effective volume deriving part 203 further derives the stress correction amount σ_{corr} from Equation (6) and Equation (7) using “the tensile strength σ_{b} of the material” inputted at step S8, “the average stress σₐᵥₑ at each position of the member” derived at step S9, “the Weibull coefficient m of the material fatigue test piece” derived at step S3, “the scale parameter σᵤ of the material” derived at step S7, and “the effective volume Vₑₚ of the member” derived at step S10.

Then, at step S11, the member cumulative fracture probability deriving part 204 derives the cumulative fracture probability P_{fp} due to fatigue of the member from Equation (9) using “the scale parameter σᵤ of the material” derived at step S7, “the effective stress (stress amplitude) σᵢₚ at each position of the member” derived at step S9, “the effective volume Vₑₚ of the member and the stress correction amount σ_{corr}” derived at step S10, and “the Weibull coefficient m of the material fatigue test piece” derived at step S3.

Then, at step S12, the fracture probability comparing part 205 determines whether or not the cumulative fracture probability P_{fp} due to fatigue of the member derived at step S11 is equal to or less than the target cumulative fracture probability. When the cumulative fracture probability P_{fp} due to fatigue of the member is not equal to or less than the target cumulative fracture probability as a result of the determination, the operation returns to step S8 and the member stress analyzing part 202 receives again input of the information about the member and external force. Then, steps S8 to S12 are repeatedly performed until the cumulative fracture probability P_{fp} due to fatigue of the member reaches the target cumulative fracture probability or less.

Note that when steps S8 and S9 are performed before step S7, the processing at steps S8 and S9 is performed after step S12 and then the processing at steps S10 to S12 is performed.

When the cumulative fracture probability P_{fp} due to fatigue of the member reaches the target cumulative fracture probability or less in step S12, the operation proceeds to step S13. Proceeding to step S13, the design stress output part 206 derives the design stress on the member based on the information derived by the member stress analyzing part 202 when the cumulative fracture probability P_{fp} reaches the target cumulative fracture probability or less, and displays the screen (GUI) indicating the design stress on the member. Then, the processing according to the flowchart in FIG. 6 ends.

As described above, in this embodiment, the effective volume Vₑₚ of the member is calculated with the stress correction amount σ_{corr} added to the effective stress (stress amplitude) σᵢₚ at each position of the member so that the fatigue strength of the member varying corresponding to the average stress varying depending on the position of the member is apparently constant at the value when the average stress on the member is 0 (zero) irrespective of the position of the member. Using the effective volume Vₑₚ of the member, the cumulative fracture probability P_{fp} due to fatigue of the member is derived. Accordingly, it is possible to evaluate the cumulative fracture probability as a numerical value in probabilistic consideration of the risk of the fatigue fracture from the inside of the member by meaningfully combining thoughts of the fatigue limit diagram, the Weibull distribution, and the effective volume of the member. More specifically, the cumulative fracture probability P_{fp} due to fatigue of the member having a complex stress distribution can be quantitatively calculated using a relatively simple “distribution of the fatigue strength of the material fatigue test piece” obtained from the result of the uniaxial fatigue test (the result of the fatigue test under the condition of applying a load on one axis) or the result of the torsional fatigue test (the result of the fatigue test under the condition of applying a torsional load). For example, a member can be designed in consideration of the fatigue fracture starting from a certain inclusion which is a probabilistic event. In contrast, conventionally, the probabilistic evaluation of the distribution of the fatigue strength of the material could be made but the result thereof could not be directly used for a member different in stress state from the material. Therefore, a member has been designed using the empirically obtained safety factor as described above. Accordingly, it was impossible to sufficiently reflect the variations in fatigue characteristic on the design of the member. In particular, the cumulative fracture probability could not be expected with a satisfactory accuracy in a region of low fracture probability. In this embodiment, an accurate fatigue design can be made as described above as compared to the conventional fatigue design determined based on the experience such as the safety factor or the like.

Further, the user selects either the result of the uniaxial fatigue test or the result of the torsional fatigue test as the fatigue characteristic of the material in this embodiment. Accordingly, the fatigue characteristic of the material can be selected according to whether the member that is the object of deriving the cumulative fracture probability P_{fp} due to fatigue is fractured mainly by compression and tension or fractured mainly by torsion. Accordingly, more accurate fatigue design can be made.

Note that the P-S-N curves are created using the result of the uniaxial fatigue test about the material fatigue test piece and the Weibull plot is further created from the P-S-N curves so that “the Weibull coefficient m of the material fatigue test piece” is derived from the Weibull plot in this embodiment. Further, the average fatigue strength σₐₛ of the material fatigue test piece is derived from the results of the plurality of uniaxial fatigue tests or the results of the plurality of torsional fatigue tests about the material fatigue test pieces according to the result of selection by the user, and the scale parameter σᵤ of the material is further derived. However, this is not always necessary. For example, the result of the uniaxial fatigue test may be not the result of the actual test but a supposed value such as the result of simulation supposing that the cumulative fracture probability distribution with respect to the stress amplitude in a certain number of repeated loading times on the assumption that the fatigue test (for example, the uniaxial fatigue test) by repeated loading with the average stress on the material constituting the member being 0 [N/mm²] is conducted is the two-parameter Weibull distribution. Further, the user may set the distribution of the cumulative fracture probability due to the fatigue of the material (two-parameter Weibull distribution) supposed as described above to derive “the Weibull coefficient m of the material fatigue test piece” and “the scale parameter σᵤ of the material.” In this case, it is unnecessary to create the P-S-N curves. Further, the user may directly set “the Weibull coefficient m of the material fatigue test piece” and “the scale parameter σᵤ of the material.” Further, “the scale parameter σᵤ of the material” can be found from the above-described Weibull plot.

Further, the effective stress (stress amplitude) σᵢₚ at each position of the member and the average stress σₐᵥₑ at each position of the member are derived by the member stress analyzing part 202 in this embodiment. However, this is not always necessary. For example, these supposed values may be directly set by the user.

Further, in this embodiment, the fatigue limit diagram has been described taking, as an example, the case using the modified Goodman relationship described in “The Society of Materials Science, Japan, Fatigue design handbook, Yokendo, Jan. 20, 1995, first edition, p. 82” and the like. However, the fatigue limit diagram is not limited to the modified Goodman relationship. For example, the Gerber diagram discussed in “The Society of Materials Science, Japan, Fatigue design handbook, Yokendo, Jan. 20, 1995, first edition, p. 82” and the like, the diagram based on the JSSC Fatigue Design Recommendation, or the relational equation estimating the effect of the stress ratio or the average stress on the fatigue strength such as the stress ratio correction equation discussed in “MURAKAMI Yukitaka, Metal Fatigue: Effect of Small Defects and Inclusions, Yokendo, Dec. 25, 2008, OD edition first edition, p. 110” may be used as the fatigue limit diagram.

Further, it is preferable that the user selects either the result of the uniaxial fatigue test or the result of the torsional fatigue test as in this embodiment, but only the result of one of the tests may be inputted and used.

### First Example

Next, a first example of the present invention will be described. In this example, the case of estimating a fatigue fracture load of a coil spring having a compressive residual stress on its surface will be described. The material constituting the coil spring is a high-tensile spring steel with a strength of 1900 [MPa] corresponding to SWOSC-V defined in JIS G 3566 and is a steel material in which there is internal fatigue fracture starting from the inclusion existing in the high-tensile spring steel.

First, a material fatigue test piece with a length of a parallel portion of 20 [mm] and a diameter of the parallel portion of 4 [mm] is prepared and subjected to the uniaxial fatigue test as described above. The test stress σₜ with a stress amplitude of 700 [MPa], 750 [Mpa], 800 [MPa], 850 [MPa], 900[MPa] was repeatedly loaded here on ten material fatigue test pieces each. Here, the uniaxial fatigue test was performed so that the average stress σₐᵥₑ at each portion of the material fatigue test piece was 0 [MPa] as described above.

The results of the uniaxial fatigue tests as described above were inputted into the member fatigue fracture probability estimating apparatus 100. The member fatigue fracture probability estimating apparatus 100 created the P-S-N curves from the results of the plurality of uniaxial fatigue tests and obtained the cumulative fracture probability distribution of the fatigue limit by the method of Japan Society of Mechanical Engineers Standard JSME S 002 (statistical fatigue test method) whose distribution function was replaced with the two-parameter Weibull distribution function. As a result, 100 was obtained as the Weibull coefficient m of the material fatigue test piece from the cumulative probability distribution (two-parameter Weibull distribution) F of the fatigue strength in the number of repeated loading times of 10⁶ times. The member fatigue fracture probability estimating apparatus 100 further derived the effective volume Vₑₛ of the material fatigue test piece using “the Weibull coefficient m of the material fatigue test piece” and “the effective stress (stress amplitude) σᵢ at each position of the material fatigue test piece” derived by the member fatigue fracture probability estimating apparatus 100 (see Equation (2)). As a result, the effective volume Vₑₛ of one material fatigue test piece was 251 [mm³].

The member fatigue fracture probability estimating apparatus 100 further derived the scale parameter σᵤ of the material using “the average fatigue strength σₐₛ of the material fatigue test piece,” “the Weibull coefficient m of the material fatigue test piece,” and “the effective volume Vₑₛ of the material fatigue test piece” obtained from the result of the uniaxial fatigue test of the material fatigue test piece (see Equation (3)). As a result, the scale parameter σᵤ of the material was 800 [MPa].

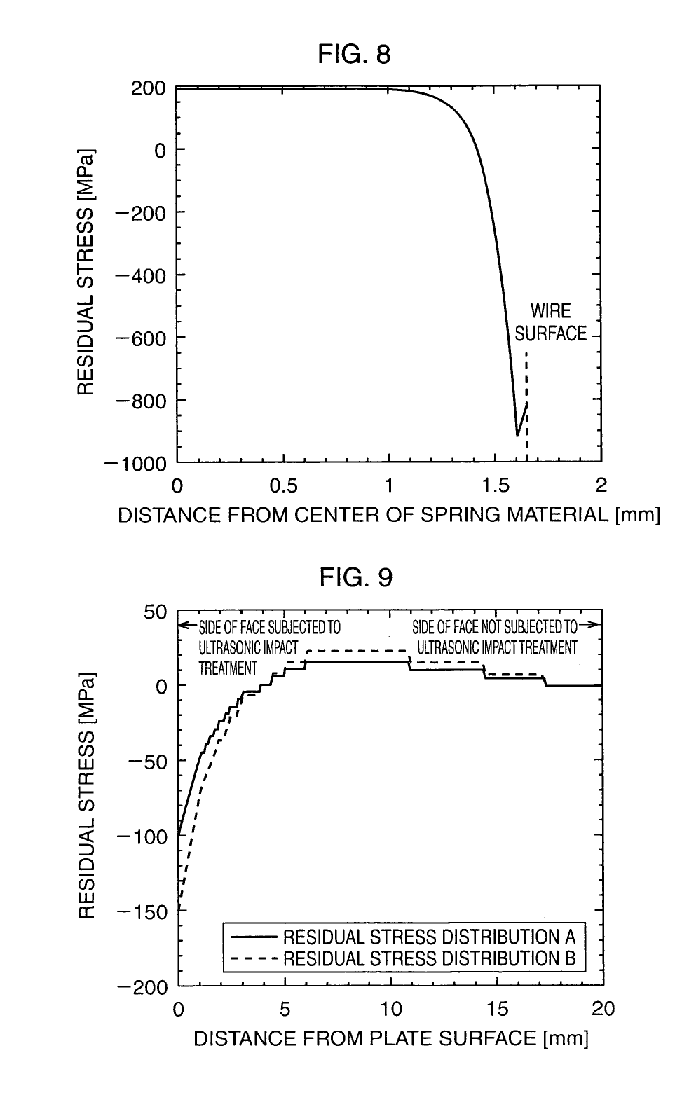

In this example, estimation of the fatigue fracture load of the coil spring made of such material was made. Here, estimation of the cumulative fracture probability of the following coil spring was made. The wire diameter of the coil spring is 3.3 [mm]. The inner diameter of the coil spring is 18 [mm] and the number of windings of the coil spring is 6 [Turn]. The distribution of the residual stress of the coil spring is caused by surface treatment by shot peening. The coil spring having a distribution of the residual stress thereof when created based on the measurement result, as illustrated in FIG. 8, was employed. Further, in consideration of the shear stress and the compressive residual stress here, the corresponding stress was employed for the effective stress (stress amplitude) σᵢ at each position of the material fatigue test piece. For the average stress σₐᵥₑ at each position of the member, the maximum principal stress was employed. In setting the coil spring in a test apparatus, the initial load (the initial value of the acting external force inputted into the member stress analyzing part 202) applied to the coil spring was set to 200 [N] and this value was regarded as the minimum load. Further, the member fatigue fracture probability estimating apparatus 100 was operated at the target cumulative fracture probability that 1 out of 50 coil springs would fracture due to fatigue in a million times of repeated loading. As a result of that, the load range (the range of the acting external force inputted into the member stress analyzing part 202) repeatedly applied to the coil spring when the derived “cumulative fracture probability P_{fp} due to fatigue of the coil spring” reached the target cumulative fracture probability was 295 [N].

Hence, for confirmation of the certainty of the result of this calculation, the uniaxial fatigue test of repeatedly applying a load in a range of 200 [N] to 495 [N] at 5 [Hz] on 100 coil springs manufactured under the same conditions as those of the above-described coil spring was conducted until the number of repeated loading times reached 1.1 million times. As a result, fatigue fracture occurred in 1 coil spring in each of 0.92 million times, 1.02 million times, 1.05 million times, and 1.07 million times, and two coil springs in 1.09 million times, so that two coil springs were fractured in about 1 million times. Accordingly, the result by the member fatigue fracture probability estimating apparatus 100 and the actual result roughly agreed with each other, whereby the effectiveness of estimation of the fatigue fracture load of the member by the member fatigue fracture probability estimating apparatus 100 was able to be confirmed.

### Second Example

Next, a second example of the present invention will be described. In this example, the case of estimating the repeated bending fatigue characteristic of a plate member having a compressive residual stress on its surface will be described. The material constituting the plate member is a high-tensile steel plate with a strength of 1300 [MPa] corresponding to SCM440 defined in JIS G 4105 and is a steel material in which there is internal fatigue fracture starting from the inclusion existing in the high-tensile steel.

First, a material fatigue test piece with a length of a parallel portion of 20 [mm] and a diameter of the parallel portion of 4 [mm] is prepared and subjected to the uniaxial fatigue test as described above. The test stress σₜ with a stress amplitude of 450 [MPa], 500 [Mpa], 550 [MPa], 600 [MPa], 650[MPa] was repeatedly loaded here on ten material fatigue test pieces each. Here, the uniaxial fatigue test was conducted so that the average stress σₐᵥₑ at each portion of the material fatigue test piece was 0 [MPa] as described above.

The results of the uniaxial fatigue tests as described above were inputted into the member fatigue fracture probability estimating apparatus 100. The member fatigue fracture probability estimating apparatus 100 created the P-S-N curves from the results of the uniaxial fatigue tests and obtained the cumulative fracture probability distribution of the fatigue limit by the method of Japan Society of Mechanical Engineers Standard JSME S 002 (statistical fatigue test method) whose distribution function was replaced with the two-parameter Weibull distribution function. As a result, 80 was obtained as the Weibull coefficient m of the material fatigue test piece from the cumulative probability distribution (two-parameter Weibull distribution) F of the fatigue strength in the number of repeated loading times of 10⁶ times. The member fatigue fracture probability estimating apparatus 100 further derived the effective volume Vₑₛ of the material fatigue test piece using “the Weibull coefficient m of the material fatigue test piece” and “the effective stress (stress amplitude) σᵢ at each position of the material fatigue test piece” derived by the member fatigue fracture probability estimating apparatus 100 (see Equation (2)). As a result, the effective volume Vₑₛ of one material fatigue test piece was 251 [mm³]. The member fatigue fracture probability estimating apparatus 100 further derived the scale parameter σᵤ of the material using “the average fatigue strength σₐₛ of the material fatigue test piece,” “the Weibull coefficient m of the material fatigue test piece,” and “the effective volume Vₑₛ of the material fatigue test piece” obtained from the result of the uniaxial fatigue test of the material fatigue test piece (see Equation (3)). As a result, the scale parameter σᵤ of the material was 578 [MPa].

An automatic ultrasonic impact apparatus was used to evenly perform ultrasonic impact treatment on the surface on one face side of the plate member that is the object of estimating the cumulative fracture probability to thereby apply a compressive residual stress on the surface on the one face side of the plate member. The distribution of the compressive residual stress applied on the plate member in this manner is illustrated in FIG. 9. In this example, a plate member with a length of 400 [mm], a width of 30 [mm], and a thickness of 20 [mm] was employed. The plate member was set in a test apparatus with the face subjected to ultrasonic impact treatment located at the lower side such that the plate member was held at a position of 50 [mm] separated from both end portions in the longitudinal direction of the plate member, and a load was applied on the middle of the plate member from the other face side (the upper side) which was not subjected to the ultrasonic impact treatment, by uniformly repeated three-point bending. Specifically, a load was repeatedly applied on the plate member at 5 [Hz] so that the surface maximum stress and the surface minimum stress on the plate member when a load was repeatedly applied on the plate member having a residual stress distribution A (see the solid line in FIG. 9) were 900 [MPa], 200 [MPa} respectively. As a result, three out of ten plate members fractured due to fatigue until the number of repeated loading times reached 2 million times. Hence, a load was repeatedly applied, under the same conditions, on the plate member having a residual stress distribution B (see the broken line in FIG. 9) obtained by changing the conditions of the ultrasonic impact treatment. As a result, all of the ten plate members did not fracture due to fatigue even when the number of repeated loading times reached 2 million times.

For confirmation of the effect due to the change in the residual stress distribution as described above, the cumulative fracture probability of the plate member was estimated by the member fatigue fracture probability estimating apparatus 100. Since the stress occurred in the plate member was only the stress substantially in the axis direction of the member, the maximum principal stress was employed for each of the effective stress (stress amplitude) σᵢ and the average stress σₐᵥₑ at each position of the material fatigue test piece. As a result, the cumulative fracture probability P_{fp} due to fatigue in the number of repeated loading times of 2 million times was 26.8[%] in the plate member having the residual stress distribution A, and the cumulative fracture probability P_{fp} due to fatigue in the number of repeated loading times of 2 million times was 1.7[%] in the plate member having the residual stress distribution B. Thus, the result by the member fatigue fracture probability estimating apparatus 100 and the actual result roughly agreed with each other, whereby the effectiveness of estimation of the repeated bending fatigue characteristic of the member by the member fatigue fracture probability estimating apparatus 100 was able to be confirmed.

### Third Example

Next, a third example of the present invention will be described. In this example, the case using the result of the torsional fatigue test will be described.

First, a round bar test piece formed of a carbon steel defined in JIS G4051 S55C and having a parallel portion with a diameter of 4 [mm] and a length of 10 [mm] is prepared as the material fatigue test piece and subjected to the torsional fatigue test as described above in which a torsional repeated load is applied on the material fatigue test piece. Here, the test stress τₜ with a stress amplitude of 280 [MPa] to 360 [MPa] was repeatedly applied in increments of 10 [MPa] on 12 material fatigue test pieces each.

The results of the torsional fatigue tests as described above were inputted into the member fatigue fracture probability estimating apparatus 100. The member fatigue fracture probability estimating apparatus 100 created the P-S-N curves from the results of the torsional fatigue tests and obtained the cumulative fracture probability distribution of the fatigue limit by the method of Japan Society of Mechanical Engineers Standard JSME S 002 (statistical fatigue test method) whose distribution function was replaced with the two-parameter Weibull distribution function. As a result, 20 was obtained as the Weibull coefficient m of the material fatigue test piece from the cumulative probability distribution (two-parameter Weibull distribution) F of the fatigue strength in the number of repeated loading times of 10⁶ times.

The member fatigue fracture probability estimating apparatus 100 further derived the effective volume Vₑₛ of the material fatigue test piece using “the Weibull coefficient m of the material fatigue test piece” and “the effective stress (stress amplitude) σᵢ at each position of the material fatigue test piece” separately derived by the member fatigue fracture probability estimating apparatus 100 (see Equation (2)). As a result, the effective volume Vₑₛ of one material fatigue test piece was 7.43 [mm³].

The member fatigue fracture probability estimating apparatus 100 further derived the scale parameter σᵤ of the material using “the average shear stress τₑₛ of the material fatigue test piece,” “the Weibull coefficient m of the material fatigue test piece,” and “the effective volume Vₑₛ of the material fatigue test piece” obtained from the result of the torsional fatigue test of the material fatigue test piece (see Equation (3)). The average shear stress τₐₛ was 317.5 [MPa]. The coefficient f is 1 to √3. Therefore, the scale parameter σᵤ of the material was 412.8 [MPa] to 715.0 [MPa].

Here, 30 test pieces in the same shape having a length at a thinnest portion of 10 [mm] and a circular cross-section with a thickness of 10 [mm] were formed using the material JIS G4501 S55C for which the scale parameter σᵤ of the material was found as described above. Fatigue tests by (1) repeated torsion, (2) rotating bending, and (3) repeated axial force were conducted on 10 test pieces each.

The surface maximum shear stress of 292 [MPa] in (1) the repeated torsional fatigue test and the maximum stress of 506 [MPa] in (2) the rotating bending test were set as test stresses respectively.

These test stresses were set by the method described in this embodiment so that the cumulative fracture probability P_{fp} was 50[%] with the scale parameter σᵤ of the material and the Weibull coefficient m set to the above-described values and the coefficient f set to √3.

As a result, in (1) the repeated torsional fatigue test, five out of ten test pieces fractured before the number of repeated loading times reached 10⁶ times. Also in (2) the rotating bending test, five out of ten test pieces fractured before the number of repeated loading times reached 10⁶ times. In (1) the repeated torsional fatigue test and in (2) the rotating bending test, the effective volume Vₐₛ is identical to be 46.5 [mm³]. The test pieces used in these tests are made of the same material and therefore identical in the scale parameter σᵤ of the material and the Weibull coefficient m. Further, considering that the average shear stress τₐₛ employed in (1) the repeated torsional fatigue test and the average fatigue strength σₐₛ employed in (2) the rotating bending test take substantially the respective average values (though not precisely), the relation of fτₐₛ=σₐₛ is established, so that the coefficient f can be calculated based on the relation. From the above, setting of f=√3 can be considered to be appropriate in this material.

Hence, in (3) the repeated axial force test, the maximum stress was set to 450 [MPa}. The cumulative fracture probability P_{fp} in the number of repeated loading times of 10⁶ time found by the method described in this embodiment with f=√3 being set from the above-described result was 67[%]. In (3) the repeated axial force test, seven out of ten test pieces fractured before the number of repeated loading times reached 10⁶ times. As described above, the result of the test and the estimation result by the method described in this embodiment substantially agreed with each other.

Note that the above-described embodiment of the present invention can be implemented by a computer executing a program. Further, a means for supplying the program to the computer, for example, a computer-readable recording medium such as a CD-ROM or the like having the program recorded thereon, or a transmission medium transmitting the program is also applicable as the embodiment of the present invention. Furthermore, a program product such as a computer-readable recording medium having the program recorded thereon is also applicable as the embodiment of the present invention. The above-described program, computer-readable recording medium, transmission medium, and program product are included in the scope of the present invention.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

Conventionally, the fatigue strength has been expected from the result of the fatigue test of the material using the empirically obtained safety factor. Therefore, conventionally, the cumulative fracture probability could not be expected with a satisfactory accuracy particularly in a region of low fracture probability. In contrast, according to the present invention, the cumulative fracture probability distribution due to fatigue of the member can be quantitatively grasped.

1. A member fatigue fracture probability estimating apparatus, comprising:
a processor to execute at least:
a first operation of acquiring, as first acquisition information, a Weibull coefficient m and a scale parameter σᵤ [N/mm²] when a cumulative fracture probability distribution with respect to a stress amplitude of a fatigue test in a certain number of repeated loading times of a material fatigue test piece made of a material constituting a member is expressed by a two-parameter Weibull distribution;
a second operation of acquiring, as second acquisition information, an amplitude σᵢₚ [N/mm²] of a maximum principal stress or a corresponding stress at each position of the member and an average stress σₐᵥₑ [N/mm²] being an average of the maximum principal stress or the corresponding stress at each position of the member;
deriving an effective volume Vₑₚ [mm³] of the member from Equation (A), in which Vₑₚ=∫{(σᵢₚ+σ_{corr})/max(σᵢₚ+σ_{corr})}^{m}dV and from Equation (B), in which σ_{corr}=σₐₚ−σᵣ; and
deriving a cumulative fracture probability P_{fp} due to fatigue of the member from Equation (C), in which P_{fp}=1−exp[−Vₑₚ{max(σᵢₚ+σ_{corr})/σᵤ}^{m}]; and
a reporting unit to report information relating to the cumulative fracture probability P_{fp} due to fatigue of the member,
wherein σₐₚ is a fatigue strength [N/mm²] of the member when the fatigue strength at each position is made uniform at a constant value using σᵢₚ+σ_{corr} as an amplitude of the stress at each position of the member, in a fatigue limit diagram representing a relation between the fatigue strength of the member and an average stress on the member, σᵣ is a fatigue strength [N/mm²] at a certain position when the average stress on the member is the average stress σₐᵥₑ at the position acquired in the second operation of acquiring, in the fatigue limit diagram, max(x) represents a maximum value of x, and ∫dv represents volume integration of the whole member.

2. The member fatigue fracture probability estimating apparatus according to claim 1, wherein the processor further executes:
acquiring, as third acquisition information, an amplitude σᵢ [N/mm²] of a maximum principal stress or a corresponding stress at each position of the material fatigue test piece; and
deriving an effective volume Vₑₛ [mm³] of the material fatigue test piece from a Equation (D) in which Vₑₛ=∫{σᵢ/max(σᵢ)}^{m}dv,
wherein the fatigue limit diagram is a modified Goodman relationship,
wherein the first operation of acquiring further acquires, as the first acquisition information, an average fatigue strength σₐₛ [N/mm²] by a fatigue test with the average stress being 0 [N/mm²] using a plurality of material fatigue test pieces made of the material constituting the member,
wherein the first operation of acquiring derives the scale parameter σᵤ [N/mm²] of the fatigue strength on the assumption that the fatigue test has been conducted on the material in a certain number of repeated loading times, from a Equation (E), in which σᵤ=σₐₛVₑₛ^{1/m}/Γ(1+1/m),
wherein the second operation of acquiring further acquires, as the second acquisition information, a tensile strength σ_{b} [N/mm²] of the material constituting the member,
wherein the effective volume Vₑₚ of the member is derived from Equation (F), in which Vₑₚ=∫{(σᵢₚ+Vₑₚ^{-1/m}σᵤΓ(1+1/m)σₐᵥₑ/σ_{b})/max(σᵢₚ+V^{-1/m}σᵤΓ(1+1/m)σₐᵥₑ/σ_{b})}^{m}dV, and
wherein Γ( ) represents a gamma function, max(x) represents a maximum value of x, and ∫dv in Equation (D) represents volume integration of the whole material fatigue test piece.

3. The member fatigue fracture probability estimating apparatus according to claim 1, wherein the first operation of acquiring includes receiving input of a result of a uniaxial fatigue test or a supposed value of the result of the uniaxial fatigue test, the uniaxial fatigue test repeatedly loading a test stress σₜ [N/mm²] regularly changed in one direction of the material fatigue test piece on the material fatigue test piece to investigate a number of repeated loading times of the stress until the material fatigue test piece breaks, conducted with the average of the maximum principal stress or the corresponding stress on the material fatigue test piece being 0, and deriving the first acquisition information using the inputted result of the uniaxial fatigue test or supposed value thereof.

4. The member fatigue fracture probability estimating apparatus according to claim 1, wherein the first operation of acquiring includes receiving input of a result of a torsional fatigue test or a supposed value of the result of the torsional fatigue test, the torsional fatigue test repeatedly loading a test stress τₜ [N/mm²] regularly changed in a shear direction of the material fatigue test piece on the material fatigue test piece to investigate a number of repeated loading times of the stress until the material fatigue test piece breaks, conducted with the average of the maximum principal stress or the corresponding stress on the material fatigue test piece being 0, and deriving the first acquisition information using the inputted result of the torsional fatigue test or supposed value thereof.

5. The member fatigue fracture probability estimating apparatus according to claim 1, wherein the processor further executes a selecting, based on an operation of an operation input unit by a user, of any one of:
a result of a uniaxial fatigue test or a supposed value thereof, the uniaxial fatigue test repeatedly loading a test stress σₜ [N/mm²] regularly changed in one direction of the material fatigue test piece on the material fatigue test piece to investigate a number of repeated loading times of the stress until the material fatigue test piece breaks, and
a result of a torsional fatigue test or a supposed value thereof, the torsional fatigue test repeatedly loading a test stress τₜ [N/mm²] regularly changed in a shear direction of the material fatigue test piece on the material fatigue test piece to investigate a number of repeated loading times of the stress until the material fatigue test piece breaks,
wherein when the result of the uniaxial fatigue test or the supposed value thereof is selected, the first operation of acquiring includes receiving input of the result of the uniaxial fatigue test or the supposed value of the result of the uniaxial fatigue test, the uniaxial fatigue test being conducted with the average of the maximum principal stress or the corresponding stress on the material fatigue test piece being 0, and deriving the first acquisition information using the inputted result of the uniaxial fatigue test or supposed value thereof, and
wherein when the result of the torsional fatigue test or the supposed value thereof is selected, the first operation of acquiring includes receiving input of the result of the torsional fatigue test or the supposed value of the result of the torsional fatigue test, the torsional fatigue test being conducted with the average of the maximum principal stress or the corresponding stress on the material fatigue test piece being 0, and deriving the first acquisition information using the inputted result of the torsional fatigue test or supposed value thereof.

6. The member fatigue fracture probability estimating apparatus according to claim 1, wherein the first operation of acquiring includes deriving the Weibull coefficient m and the scale parameter σᵤ [N/mm²] as the first acquisition information supposing that a cumulative fracture probability distribution with respect to a stress amplitude in a certain number of repeated loading times on the assumption that the fatigue test by repeated loading has been conducted with the average stress on the material constituting the member being 0 [N/mm²] is a two-parameter Weibull distribution.

7. The member fatigue fracture probability estimating apparatus according to claim 1, wherein the second operation of acquiring includes receiving input of a shape of the member, an acting external force acting on the member, a residual stress of the member, and a characteristic of a material constituting the member, and using the inputted information to derive the second acquisition information.

8. A member fatigue fracture probability estimating method, the method comprising:
acquiring, as first acquisition information, a Weibull coefficient m and a scale parameter σᵤ [N/mm²] when a cumulative fracture probability distribution with respect to a stress amplitude of a fatigue test in a certain number of repeated loading times of a material fatigue test piece made of a material constituting a member is expressed by a two-parameter Weibull distribution;
acquiring, as second acquisition information, an amplitude σᵢₚ [N/mm²] of a maximum principal stress or a corresponding stress at each position of the member and an average stress σₐᵥₑ [N/mm²] being an average of the maximum principal stress or the corresponding stress at each position of the member;
deriving an effective volume Vₑₚ [mm³] of the member from Equation (A), in which Vₑₚ=∫{(σᵢₚ+σ_{corr})/max(σᵢₚ+σ_{corr})}^{m}dV, and from Equation (B), in which σ_{corr}=σₐₚ−σᵣ; and
deriving a cumulative fracture probability P_{fp} due to fatigue of the member from Equation (C), in which P_{fp}=1−exp[−Vₑₚ{max(σᵢₚ+σ_{corr})/σᵤ}^{m}]; and
reporting information relating to the cumulative fracture probability P_{fp} due to fatigue of the member derived by the member fracture probability deriving operation,
wherein σₐₚ is a fatigue strength [N/mm²] of the member when the fatigue strength at each position is made uniform at a constant value using σᵢₚ+σ_{corr} as the amplitude of the stress at each position of the member, in a fatigue limit diagram representing a relation between the fatigue strength of the member and the average stress on the member, σᵣ is a fatigue strength [N/mm²] at a certain position when the average stress on the member is the average stress σₐᵥₑ at the position acquired in the second acquiring operation, in the fatigue limit diagram, max(x) represents a maximum value of x, and ∫dv represents volume integration of the whole member.

9. The member fatigue fracture probability estimating method according to claim 8, further comprising:
acquiring, as third acquisition information, an amplitude σᵢ [N/mm²] of a maximum principal stress or a corresponding stress at each position of the material fatigue test piece; and
deriving an effective volume Vₑₛ [mm³] of the material fatigue test piece from Equation (D), in which Vₑₛ=∫{σᵢ/max(σᵢ)}^{m}dv,
wherein the fatigue limit diagram is a modified Goodman relationship,
wherein the first acquiring operation further acquires, as the first acquisition information, an average fatigue strength σₐₛ [N/mm²] by a fatigue test with the average stress being 0 [N/mm²] using a plurality of material fatigue test pieces made of the material constituting the member,
wherein the first acquiring operation derives the scale parameter σᵤ [N/mm²] of the fatigue strength on the assumption that the fatigue test has been conducted on the material in a certain number of repeated loading times, from Equation (E), in which σᵤ=σₐₛVₑₛ^{1/m}/Γ(1+1/m),
wherein the second acquiring operation further acquires, as the second acquisition information, a tensile strength σ_{b} [N/mm²] of the material constituting the member,
wherein the member effective volume deriving operation derives the effective volume Vₑₚ of the member from Equation (F), in which
V=∫{(σᵢₚ+Vₑₚ^{-1/m}σᵤΓ(1+1/m)σₐᵥₑ/σ_{b})/max(σᵢₚ+V^{-1/m}σᵤΓ(1+1/m)σₐᵥₑ/σ_{b})}^{m}dV, and
wherein where Γ( ) represents a gamma function, max(x) represents a maximum value of x, and ∫dv in Equation (D) represents volume integration of the whole material fatigue test piece.

10. The member fatigue fracture probability estimating method according to claim 8, wherein the first acquiring operation includes receiving input of a result of a uniaxial fatigue test or a supposed value of the result of the uniaxial fatigue test, the uniaxial fatigue test repeatedly loading a test stress σₜ [N/mm²] regularly changed in one direction of the material fatigue test piece on the material fatigue test piece to investigate a number of repeated loading times of the stress until the material fatigue test piece breaks, conducted with the average of the maximum principal stress or the corresponding stress on the material fatigue test piece being 0, and deriving the first acquisition information using the inputted result of the uniaxial fatigue test or supposed value thereof.

11. The member fatigue fracture probability estimating method according to claim 8, wherein the first acquiring operation includes receiving input of a result of a torsional fatigue test or a supposed value of the result of the torsional fatigue test, the torsional fatigue test repeatedly loading a test stress τₜ [N/mm²] regularly changed in a shear direction of the material fatigue test piece on the material fatigue test piece to investigate a number of repeated loading times of the stress until the material fatigue test piece breaks, conducted with the average of the maximum principal stress or the corresponding stress on the material fatigue test piece being 0, and deriving the first acquisition information using the inputted result of the torsional fatigue test or supposed value thereof.

12. The member fatigue fracture probability estimating method according to claim 8, further comprising:
selecting, based on an operation of an operation input unit by a user, any one of:
a result of a uniaxial fatigue test or a supposed value thereof, the uniaxial fatigue test repeatedly loading a test stress σₜ [N/mm²] regularly changed in one direction of the material fatigue test piece on the material fatigue test piece to investigate a number of repeated loading times of the stress until the material fatigue test piece breaks, and
a result of a torsional fatigue test or a supposed value thereof, the torsional fatigue test repeatedly loading a test stress τₜ [N/mm²] regularly changed in a shear direction of the material fatigue test piece on the material fatigue test piece to investigate a number of repeated loading times of the stress until the material fatigue test piece breaks,
wherein when the result of the uniaxial fatigue test or the supposed value thereof is selected by the selection operation, the first acquiring operation includes receiving input of the result of the uniaxial fatigue test or the supposed value of the result of the uniaxial fatigue test, the uniaxial fatigue test being conducted with the average of the maximum principal stress or the corresponding stress on the material fatigue test piece being 0, and deriving the first acquisition information using the inputted result of the uniaxial fatigue test or supposed value thereof, and
wherein when the result of the torsional fatigue test or the supposed value thereof is selected by the selection operation, the first acquiring operation includes receiving input of the result of the torsional fatigue test or the supposed value of the result of the torsional fatigue test, the torsional fatigue test being conducted with the average of the maximum principal stress or the corresponding stress on the material fatigue test piece being 0, and deriving the first acquisition information using the inputted result of the torsional fatigue test or supposed value thereof.

13. The member fatigue fracture probability estimating method according to claim 8, wherein the first acquiring operation includes deriving the Weibull coefficient m and the scale parameter σᵤ [N/mm²] as the first acquisition information supposing that a cumulative fracture probability distribution with respect to a stress amplitude in a certain number of repeated loading times on the assumption that the fatigue test by repeated loading has been conducted with the average stress on the material constituting the member being 0 [N/mm²] is a two-parameter Weibull distribution.

14. The member fatigue fracture probability estimating method according to claim 8, wherein the second acquiring operation includes receiving input of a shape of the member, an acting external force acting on the member, a residual stress of the member, and a characteristic of a material constituting the member, and using the inputted information to derive the second acquisition information.

15. A computer readable medium having a computer program, which is executable by a processor, comprising
a program code arrangement having program code for estimating a member fatigue fracture probability by performing the following:
acquiring a Weibull coefficient m and a scale parameter σᵤ [N/mm²] when a cumulative fracture probability distribution with respect to a stress amplitude of a fatigue test in a certain number of repeated loading times of a material fatigue test piece made of a material constituting a member is expressed by a two-parameter Weibull distribution;
acquiring an amplitude σᵢₚ [N/mm²] of a maximum principal stress or a corresponding stress at each position of the member and an average stress σₐᵥₑ [N/mm²] being an average of the maximum principal stress or the corresponding stress at each position of the member;
deriving an effective volume Vₑₚ [mm³] of the member from following Equation (A), in which
Vₑₚ=∫{(σᵢₚ+σ_{corr})/max(σᵢₚ+σ_{corr})}^{m}dV, and from Equation (B), in which σ_{corr}=σₐₚ−σᵣ; and
deriving a cumulative fracture probability P_{fp} due to fatigue of the member from Equation (C), in which P_{fp}=1−exp[−Vₑₚ{max(σᵢₚ+σ_{corr})/σᵤ}^{m}]; and
reporting information relating to the cumulative fracture probability P_{fp} due to fatigue of the member derived by the member fracture probability deriving operation,
wherein where σₐₚ is a fatigue strength [N/mm²] of the member when the fatigue strength at each position is made uniform at a constant value using σᵢₚ+σ_{corr} as the amplitude of the stress at each position of the member, in a fatigue limit diagram representing a relation between the fatigue strength of the member and the average stress on the member, σᵣ is a fatigue strength [N/mm²] at a certain position when the average stress on the member is the average stress σₐᵥₑ at the position acquired in the second acquiring operation, in the fatigue limit diagram, max(x) represents a maximum value of x, and ∫dv represents volume integration of the whole member.
